(19) United States
(12) Patent Application Publication
(10) Pub. No.: US 2024/0159913 A1
(43) Pub. Date: May 16, 2024

(54) Method for Processing and Assessing the Integrity of GNSS Position Information

(71) Applicant: Robert Bosch GmbH, Stuttgart (DE)

(72) Inventor: Tomasz Bien, Ludwigsburg (DE)

(21) Appl. No.: 18/496,876

(22) Filed: Oct. 29, 2023

(30) Foreign Application Priority Data
Nov. 15, 2022 (DE) 10 2022 212 146.5

(51) Int. Cl. G01S 19/39

(52) U.S. Cl. CPC G01S 19/396

(57) ABSTRACT

A method for processing and assessing the integrity of GNSS position information incudes (a) receiving GNSS signals and ascertaining a preliminary GNSS position, (b) checking the preliminary GNSS position ascertained in step (a) against a first condition and discarding the preliminary GNSS position if the first condition is satisfied, (c) ascertaining the integrity of the GNSS position based on an integrity criterion ascertained in the field which was determined excluding GNSS positions that satisfy the first condition, and (d) if the GNSS position was not discarded in step (b), outputting the preliminary GNSS position as a verified GNSS position.

This application claims priority under 35 U.S.C. § 119 to patent application no. DE 10 2022 212 146.5, filed on Nov. 15, 2022 in Germany, the disclosure of which is incorporated herein by reference in its entirety.

### BACKGROUND

GNSS receivers have become increasingly common and are used in a variety of technological fields. Navigating and ascertaining positions using GNSS (possibly in combination with the use of map data) and determining the exact time are particularly frequent applications.

GNSS technology enables precise determination of the absolute position, speed, time, and orientation in space. GNSS technology is therefore in particular suitable for automotive applications and is widely used here. A GNSS position is in particular intended to be understood in the following as an information set consisting of position information, speed, time, and orientation information. Individual parts of this information, in particular the position information, are addressed as well, however.

GNSS reception with GNSS receivers is based on processes that take place partly in orbit, partly on the ground, and partly in the GNSS receiver itself. The transmission of the electromagnetic signals from the satellites takes place in orbit, wherein the signals contain specific information (codes) that can be received and make the detection of the satellite, the propagation times, and thus the distances from the satellites to the receiver measurable. The codes also make it possible to identify the satellite from which the respective signal is being transmitted. This code is received by and processed in the GNSS receiver, wherein generally two different types of processing are carried out.

The GNSS signals are also used to obtain time information that describes the propagation times of signals on their way from the satellite to the GNSS receiver.

The signals are additionally evaluated to obtain information about the satellites, in particular information about the orbits of the satellites.

By combining these two pieces of information, positions can be calculated in the receiver based on the GNSS satellite signals.

GNSS receivers are often used in conjunction with other sensors, for example in combination with inertial sensors, wheel speed sensors, other types of speed sensors, etc. The use of additional sensors improves navigation, in particular position determination. A combined navigation system comprising inertial sensors and GNSS receivers is able to determine orientation in three dimensions (yq roll and pitch) and, together with the position and speed, preferably compiles a complete set of position information.

This set of information is provided with high accuracy and reliability. This is in particular important in autonomous driving applications in which a high degree of safety is required. A drop in the accuracy and reliability of the provided position information can pose a significant problem. Due to the great complexity of all of the available information, the effort required to decide whether the provided position information is high quality and suitable for an upcoming task in the operation of a vehicle can be a major problem.

When using GNSS position information for semi-autonomous or highly autonomous driving, the assessment of the integrity of said GNSS position information is of utmost importance. For a variety of software functions, it is therefore extremely important to have a reliable assessment of whether the information meets specified minimum levels of integrity. The term “integrity” here is in particular intended to mean a certainty with which the provided position information has a specified minimum accuracy. One integrity criterion could, for example, be that there should be a probability of less than 1 in 1 billion that the accuracy of the GNSS position information is less than one meter.

Based on this, the intent is to propose a novel approach with which difficult conditions for position determination can be recognized and processed and very good integrity can be achieved in a specific area.

The object of the present disclosure is to at least partially solve the problems described with reference to the prior art. This object is achieved with the disclosure according to the features of the methods described below. Further advantageous configurations are also specified in the description and in particular also in the description of the figures. It should be noted that the skilled person can combine the individual features together in a technologically sensible manner and thus arrive at further configurations of the disclosure.

### SUMMARY

Described here is a method for processing and assessing the integrity of GNSS position information comprising the following steps:
a) receiving GNSS signals and ascertaining a preliminary GNSS position;
b) checking the preliminary GNSS position ascertained in step a) against a first condition and discarding the preliminary GNSS position if the first condition is satisfied;
c) ascertaining the integrity of the GNSS position based on an integrity criterion ascertained in the field which was determined excluding GNSS positions that satisfy the first condition; and,
d) if the GNSS position was not discarded in step b), outputting the preliminary GNSS position as a verified GNSS position.

A typical scenario in which the accuracy and reliability of provided GNSS information decreases is in large cities, such as Frankfurt or Chicago, where there are high-rise buildings that cause multipath propagation of the GNSS signals as they travel from the satellite to the GNSS receiver. In such scenarios, in particular the visibility of satellites decreases. In other words, fewer satellites are visible to the GNSS receiver along a continuous signal path. The satellites are obscured by high-rise buildings, for example.

The intent here in this context is to present a method with which GNSS receivers can be prevented from outputting incorrect or erroneous position information. This method reacts to very clear, definite conditions. The aspects of safety and integrity are combined here under the term “verified”. The level of certainty of the accuracy and the level of integrity required for a GNSS position to still be a verified position within the meaning of step d) can be defined depending on the application of the described method. A verified GNSS position is thus a GNSS position that satisfies the integrity criterion. If appropriate, the integrity ascertained in step c) with the integrity criterion can also be output in step d) along with the GNSS position, and the GNSS position and the ascertained integrity of said GNSS position then together form the verified GNSS position as a type of data set.

The essence of the method is that a clear condition is specified which is used in step b) to discard a GNSS position, wherein this condition was also applied to determine the integrity criterion in the field that was used in step c) to ascertain the integrity of the GNSS position.

The integrity criterion, for instance, indicates the likelihood that a specific position will exceed a specific inaccuracy. In particular for highly autonomous driving applications, it is critically important that the ascertained GNSS positions have a high accuracy.

Integrity criteria that are used to evaluate the accuracy of GNSS positions are generally ascertained in the field.

Integrity is more often evaluated empirically, taking into account how often outliers that lead to GNSS positions that are no longer acceptable occur in the GNSS positions.

It has been found that accuracy problems occur in particular when specific conditions are satisfied. The approach of the here-described method is to use the same conditions to ascertain the integrity criteria in the field as are also used to discard the GNSS positions according to step b).

It has, for instance, been found that particularly high inaccuracies of position determinations occur regularly in specific areas, e.g., the Frankfurt city center. If positions in the Frankfurt city center are now generally discarded in step b), the integrity criterion with which the integrity of positions is generally determined can also be carried out excluding field travel/position determinations in the Frankfurt city center. This makes it possible to achieve a significantly improved integrity value and thus significantly improved integrity can be ascertained in step c) for all positions outside of the Frankfurt city center. This can be done with a high level of certainty.

It is particularly advantageous if an unavailability flag indicating an unavailability of verified GNSS position information is output in step d) if a verified GNSS position is not output in step d).

According to the here-described method, it is proposed that no position information be provided to higher-level control systems if no verified GNSS position has been ascertained as explained and thus incorrect GNSS positions could possibly be output. If appropriate, the unavailability flag is then used to communicate that there is an unavailability of verified GNSS positions.

It is also advantageous if geographic criteria are stored as positions and/or routes in a database and are retrieved from the database to carry out step b).

It is also advantageous if the first condition includes checking a distance of the preliminary GNSS position of at least one specified position, wherein the distance is compared with a radius distance which can be retrieved for the at least one specified position.

It is furthermore advantageous if the first condition includes checking whether the preliminary GNSS position is within a polygon of specified positions.

According to the first condition, coordinates of areas in which GNSS reception is problematic are preferably used. Such coordinates are preferably permanently stored and problematic reception conditions are identified based on these coordinates. It has been found that only a relatively small number of areas across Europe, or even across the world, have to be excluded with the first condition to be able to ascertain significantly improved integrities in step c). The Frankfurt city center, for example, is an area that should be excluded. If between 100 and 1,0000 areas across the world are excluded using coordinates, a relatively small amount of memory and computational effort are needed in a GNSS receiver to reliably realize the method.

The need for a simple approach to determine whether position information is usable or not exists in particular in the field of autonomous driving, where the decision of whether position information is usable has be made quickly and decisively.

The here-described method proposes an approach that addresses this need quite specifically.

To carry out the described method, the coordinates preferably stored in a database are those in areas in which the reception of GNSS signals is generally difficult.

The method is in particular used to ascertain a verified GNSS position, based on which the decision of whether an autonomous driving operation of a vehicle is possible or not is made.

Autonomous driving applications for vehicles are primarily offered in relatively simple road situations, such as driving on the freeway.

It has been found that the determination of GNSS positions is particularly difficult in some regions (in particular in some locations in Europe) and that incorrect positions are regularly output.

It has further been found that these locations are often precisely those places in which the user of a vehicle is not interested in certain functions of the vehicle (for example autonomous driving) anyway, or these functions cannot be used by the customer anyway. These include the roads near the Commerzbank building in Frankfurt or the La Defense district in Paris. Autonomous driving of the vehicle would not be possible there anyway or would not even be desired by the driver.

According to the here-described method, such locations can be stored, for example as coordinates and a radius, in a database in the memory of a GNSS receiver. There is in particular no need for a map in the GNSS receiver in which the reception of GNSS satellite signals is particularly difficult

(potentially high errors). The intent is that no integrous signals should be offered if the GNSS receiver is located in these locations, (e.g., the PL Valid flag would be set to Invalid in the VMPS).

The advantage of this approach is that extremely high errors in the immediate vicinity of tall buildings could be avoided in the known locations. This makes it possible to provide higher integrity assurances, for instance, with the same system and with the same amount of protection. There is no need for further checking of the integrity of the values at the respective stored positions that are checked with the first condition in step b). Large errors are avoided in step b) on a data level already, because the first condition can be used on a data level with very little effort to recognize that an integrous/verified position cannot be output.

It is also advantageous if the preliminary position is output in step d) as an unverified position.

Such an unverified GNSS position can be used for processes for which a verified GNSS position is not necessary, for example. Such a process would be the operation of a standard navigation device, for instance, that facilitates navigation for a driver of a vehicle but does not allow intervention in the operation of the motor vehicle itself.

Also described here is a GNSS receiver comprising at least one processor that is adapted/configured such that it carries out the described method or is suitable for carrying out the described method.

It should be noted that the particular advantages and design features described in connection with the above-described method are also applicable and transferable to the GNSS receivers described in the following.

Further described here is a method for creating at least one integrity criterion for GNSS position information, comprising the following steps:
receiving GNSS signals and ascertaining a preliminary GNSS position;
ii) checking the preliminary GNSS position ascertained in step i) against a first condition and discarding the preliminary GNSS position if the first condition is satisfied; and
iii) creating the integrity criterion based on GNSS positions that were not discarded in step ii).

The implementation of the method for creating an integrity criterion preferably includes carrying out a plurality of tests with which GNSS positions are determined and then respectively checking the accuracy of the GNSS position using comparisons. For example, a large number of GNSS positions are ascertained (e.g., more than one million GNSS positions or even more than one billion GNSS positions) and then an accuracy is determined for each GNSS position. This can be done by comparing a GNSS position to an exactly known position at the location of the determination, for instance, and ascertaining a deviation. Then it is checked how many of the ascertained GNSS positions have an accuracy (or a deviation from the exactly known position) that is greater than a limit value. If the limit value is 1 meter, for example, and only one GNSS position out of a billion determined GNSS positions deviates by more than one meter from the exact position, the integrity of the position can be stated as 1:1 billion. This is just a simple example of how an integrity criterion could be defined, but the principle is easy to understand.

It is now proposed here that GNSS positions that satisfy a first condition be discarded in step ii) to create the integrity criterion.

The first condition in particular includes GNSS positions, the determination of which is regularly highly inaccurate. An integrity criterion can improve significantly if such positions are not taken into account from the very beginning when creating the integrity criterion in step iii). Therefore, increased integrity (accuracy) can be assumed for all GNSS positions that do not satisfy the first condition.

The method for creating the integrity criterion is in particular used to provide an integrity criterion for step c) of the method for processing and assessing the integrity of GNSS position information.

Essential to this approach is that the first condition that is used in step b) of the method for processing and assessing the integrity of GNSS position information is the same condition as the first condition that is used in step ii) of the method for creating the integrity criterion.

Since GNSS positions that fall under this first condition are discarded in step b), it is not critical that such GNSS positions are discarded in step ii) as well.

### BRIEF DESCRIPTION OF THE DRAWINGS

The disclosure and the technical environment of the disclosure will be explained in more detail in the following with reference to the figures. The figures show preferred embodiment examples to which the disclosure is not limited. It should in particular be noted that the figures and in particular the size relationships shown in the figures are merely schematic. The figures show:

FIG. 1: a first example of a first condition for the described method;

FIG. 2: a second example of a first condition for the described method;

FIG. 3: a GNSS receiver with which the described method is carried out in a schematic illustration.

### DETAILED DESCRIPTION

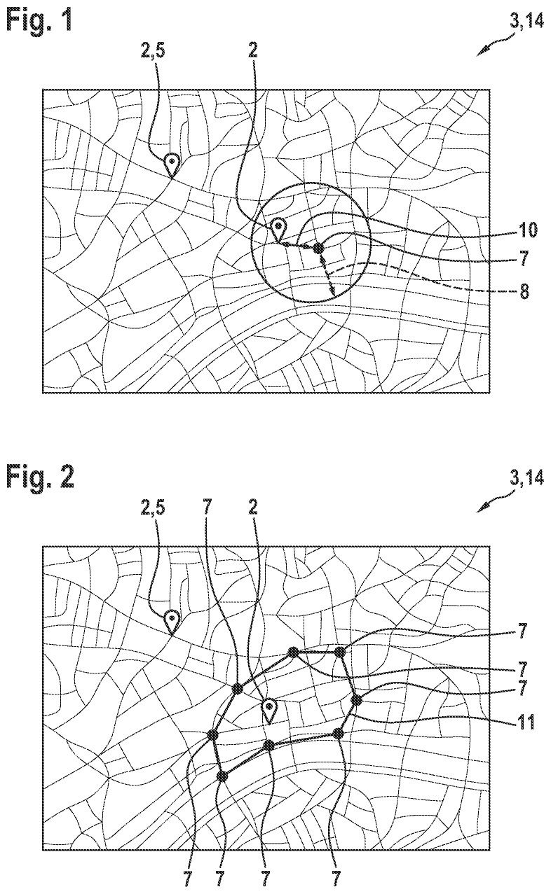

FIG. 1 and FIG. 2 each show a map 14 on which the existence of a first condition 3 can be seen. The map 14 is not needed to check the first condition 3 itself, but is included here merely to illustrate the effect of the first condition 3.

According to FIG. 1, the first condition 3 is defined in the form of stored position data 7 and stored route data 8. The position data 7 here are a position within the city center of Frankfurt near the Commerzbank Tower. The route data 8 here are a radius around this position, in which the first condition 3 should take effect and certain preliminary GNSS positions 2 should be discarded. This first condition 3 can be checked using a very simple calculation, in which the vectorial difference between the preliminary GNSS position 2 and the position stored in the position data 7 is calculated in order to from it determine the distance 10. The distance 10 can be compared with the radius stored as route data 8. FIG. 1 also shows a preliminary GNSS position 2 that does not satisfy the second condition 4 and can be output as the verified GNSS position 5.

In FIG. 2, individual positions which together form a polygon 11 that defines a spatial area on the map 14 are defined as position data 7. The first condition 3 checks whether a preliminary GNSS position 2 is within the polygon 11 or not. This test, too, can be carried out at a purely geometric level without the use of map 14.

For the first condition 3, areas in which the first condition 3 is satisfied generally cover a relatively large area around a location such as the Commerzbank Tower in the Frankfurt city center, where ascertaining exact GNSS positions is very problematic. In such areas, GNSS positions that lie outside the areas could of course also be output as incorrect GNSS positions, so that the first condition 3 would not be satisfied. The intent is that this be avoided. Therefore, for example, a radius or polygon 11 around a position at which the determination of GNSS positions is difficult is preferably made so large that there is a safety area around an inner zone that still satisfies the first condition 3. The determination of GNSS positions in the inner zone is really and truly impaired. The safety area defines the area in which certain positions that are determined incorrectly inside the inner zone can lie.

For the implementation of the here-described methods, it is not important to distinguish between the inner zone and the safety area. The first condition 3 is preferably configured such that it is in principle satisfied for GNSS positions in the inner zone and safety areas.

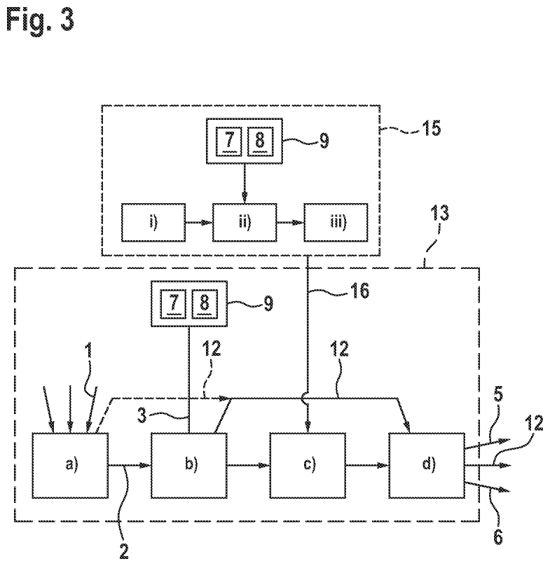

FIG. 3 schematically shows a GNSS receiver 13 for carrying out the described method together with a schematic illustration of the method. The method steps a), b), c), and d), which are carried out one after the other with the GNSS receiver 13, can be seen. The preliminary GNSS position 2 is determined first in step a) using GNSS signals 1. This preliminary GNSS position 2 is then checked in step b) with the first condition 3. This is done by referring to a database 9 in which position data 7 and/or route data 8 are stored. The integrity of the GNSS position is then ascertained in step c) on the basis of an integrity criterion 16 if the first condition 3 is not satisfied. This involves the use of an integrity criterion 16 determined, for example, with an integrity assessment system 15 that is operated in accordance with the method steps i), ii), and iii) to create at least one integrity criterion 16 for GNSS position information. The same first condition 3 that is also used in step b) is preferably used in step ii). The integrity assessment system 15 preferably uses a database 9 that is incorporated in said integrity assessment system 15 and preferably contains the same position data 7 and/or route data 8 that are applied as the first condition 3 in step ii) according to step b). In step d), then, the preliminary GNSS position 2 is output as the verified GNSS position 5. If it is not possible to output a verified GNSS position 5, an unavailability flag 6 can be output. It may also be possible for the preliminary GNSS position 2 from step a) to be transmitted even if the first condition 3 is satisfied and output classified as an unverified GNSS position 12. Such an unverified GNSS position 12 can be used for processes for which a verified GNSS position 5 is not necessary, for example. Such a process would be the operation of a standard navigation device, for instance, that facilitates navigation for a driver of a vehicle but does not allow intervention in the operation of the motor vehicle itself.

What is claimed is:

1. A method for processing and assessing the integrity of GNSS position information, comprising:
a) receiving GNSS signals and ascertaining a preliminary GNSS position;
b) checking the preliminary GNSS position ascertained in step a) against a first condition and discarding the preliminary GNSS position if the first condition is satisfied;
c) ascertaining the integrity of the GNSS position based on an integrity criterion ascertained in the field which was determined excluding GNSS positions that satisfy the first condition; and
d) if the GNSS position was not discarded in step b), outputting the preliminary GNSS position as a verified GNSS position.

2. A method according to claim 1, wherein an unavailability flag indicating an unavailability of verified GNSS position information is output in step d) if a verified GNSS position is not output in step d).

3. A method according to claim 1, wherein the first condition includes a geographic criterion which is checked against the preliminary GNSS position received in step a).

4. A method according to claim 3, wherein geographic criteria are stored as position data and/or route data in a database and are retrieved from the database to carry out step b).

5. A method according to claim 3, wherein:
the first condition includes checking a distance of the preliminary GNSS position from at least one position specified by position data, and
the distance is compared with a radius distance which can be retrieved as route data for the at least one specified position data.

6. A method according to claim 3, wherein the first condition includes checking whether the preliminary GNSS position is within a polygon of specified position data.

7. A method according to claim 1, wherein the preliminary GNSS position is output in step d) as an unverified position if it is not output as a verified GNSS position.

8. A GNSS receiver comprising at least one processor which is configured to carry out the method according to claim 1.

9. A method for creating at least one integrity criterion for GNSS position information, comprising:
i) receiving GNSS signals and ascertaining a preliminary GNSS position;
ii) checking the preliminary GNSS position ascertained in step i) against a first condition and discarding the preliminary GNSS position if the first condition is satisfied; and
iii) creating the integrity criterion based on GNSS positions that were not discarded in step ii).
